(19) United States
(12) Patent Application Publication
(10) Pub. No.: US 2024/0320817 A1
(43) Pub. Date: Sep. 26, 2024

(54) WAFER ARTIFICIAL LEARNING AND DISCOVERY OBSERVER

(71) Applicant: International Business Machines Corporation, Armonk, NY (US)

(72) Inventors: Andrew C. M. HICKS, Highland, NY (US); Michael Anthony GAGLIARDI, Somerset, MA (US); Nnaemeka Mcdonald ELUAGU, Poughkeepsie, NY (US); Daniel Nicolas GISOLFI, Hopewell Junction, NY (US)

(21) Appl. No.: 18/189,913

(22) Filed: Mar. 24, 2023

(51) Int. Cl. G06T 7/00; G06V 10/764; G06V 10/77

(52) U.S. Cl. CPC G06T 7/001; G06V 10/764; G06V 10/7715; G06T 2207/20076; G06T 2207/20081; G06T 2207/20084; G06T 2207/20212; G06T 2207/30148

(57) ABSTRACT

Techniques are provided for semiconductor defect loss mitigation. In one embodiment, the techniques involve identifying, based on an indicator, a subset of an input image of a semiconductor, generating, based on the subset of the input image, a composite defect image that represents a collection of pixels that are probabilistic drivers of a classification of a semiconductor defect, identifying, via a coordinate system, a set of potential defects of a first semiconductor, generating, based on the coordinate system and the identified set of potential defects, tags of the first semiconductor, generating, based on the tags of the first semiconductor, a potential defect image, and comparing the potential defect image to the composite defect image to determine a classification of an actual defect represented by the potential defect image.

### BACKGROUND

The present invention relates to semiconductor manufacturing, and more specifically, to predicting, tracking, and mitigating defects related to the semiconductor manufacturing process.

### SUMMARY

A method is provided according to one embodiment of the present disclosure. The method includes identifying, based on an indicator, a subset of an input image of a semiconductor; generating, based on the subset of the input image, a composite defect image that represents a collection of pixels that are probabilistic drivers of a classification of a semiconductor defect; identifying, via a coordinate system, a set of potential defects of a first semiconductor; generating, based on the coordinate system and the identified set of potential defects, tags of the first semiconductor; generating, based on the tags of the first semiconductor, a potential defect image; and comparing the potential defect image to the composite defect image to determine a classification of an actual defect represented by the potential defect image.

A system is provided according to one embodiment of the present disclosure. The system includes a processor; and memory or storage comprising an algorithm or computer instructions, which when executed by the processor, performs an operation that includes: identifying, based on an indicator, a subset of an input image of a semiconductor; generating, based on the subset of the input image, a composite defect image that represents a collection of pixels that are probabilistic drivers of a classification of a semiconductor defect; identifying, via a coordinate system, a set of potential defects of a first semiconductor; generating, based on the coordinate system and the identified set of potential defects, tags of the first semiconductor; generating, based on the tags of the first semiconductor, a potential defect image; and comparing the potential defect image to the composite defect image to determine a classification of an actual defect represented by the potential defect image.

A computer-readable storage medium having computer-readable program code embodied therewith, the computer-readable program code executable by one or more computer processors to perform an operation, is provided according to one embodiment of the present disclosure. The operation includes identifying, based on an indicator, a subset of an input image of a semiconductor; generating, based on the subset of the input image, a composite defect image that represents a collection of pixels that are probabilistic drivers of a classification of a semiconductor defect; identifying, via a coordinate system, a set of potential defects of a first semiconductor; generating, based on the coordinate system and the identified set of potential defects, tags of the first semiconductor; generating, based on the tags of the first semiconductor, a potential defect image; and comparing the potential defect image to the composite defect image to determine a classification of an actual defect represented by the potential defect image.

### BRIEF DESCRIPTION OF THE DRAWINGS

FIG. 1 illustrates a computing environment, according to one embodiment.

FIG. 2 illustrates a convolutional neural network, according to one embodiment.

FIG. 3 illustrates a flowchart of a method of implementing a machine learning algorithm to generating a composite defect image, according to one embodiment.

FIG. 4 illustrates a flowchart of a method of implementing a prediction and recommendation algorithm to predict potential semiconductor defects and generate recommendations for defective semiconductors, according to one embodiment.

### DETAILED DESCRIPTION

Traditional semiconductor manufacturing processes often produce defective products that pass quality assurance checks and are put on the market. The defects may not be revealed until after the defective semiconductor are purchased and used by consumers. When a failed or inoperable semiconductor product is returned by a consumer, the defects of the product are generally diagnosed via a manual failure analysis process. Afterwards, results of the failure analysis process are used to adjust the manufacturing process to prevent further production of the defective semiconductors products. However, because the failure analysis process is time consuming, the manufacturer can continue to produce defective products while the failure analysis process is taking place.

Embodiments of the present disclosure improve semiconductor manufacturing defect mitigation processes by providing a new machine learning algorithm that generates a composite defect image of semiconductor defects, and a prediction and recommendation (PR) algorithm that predicts semiconductor defects and recommends uses for defective semiconductor products to mitigate losses due to the defects. In one embodiment, the machine learning algorithm is trained to find a small subset of pixels (from training images) that most influences an output determination of whether images of semiconductor layers include a defect. The machine learning algorithm can generate the composite defect image from the subset of pixels. The PR algorithm can implement the machine learning algorithm to compare the composite defect image to input images of semiconductor layers, and predict whether the input images show a defect. In one embodiment, the input images include potential defects that are demarcated on a coordinate system during the manufacturing process. The PR algorithm can use the defect predictions to generate a recommended use, or associated sales price, for semiconductors predicted to have defects.

One benefit of the disclosed embodiments is to enable rapid identification of semiconductor defects, which reduces the time required to perform failure analysis processes on defective semiconductor products, thereby reducing manufacturing waste by stemming production that would be ongoing while traditional failure analysis processes are performed. Further, embodiments of the present disclosure enable the identification of defects via a predictive analysis in lieu of traditional failure analysis processes, thereby reducing the labor and cost associated with traditional failure analysis processes. Further, embodiments of the present disclosure enable streamlined repurposing of defective semiconductor products, which prevents failures of the defective products used by consumers, thereby reducing economic and environmental waste.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

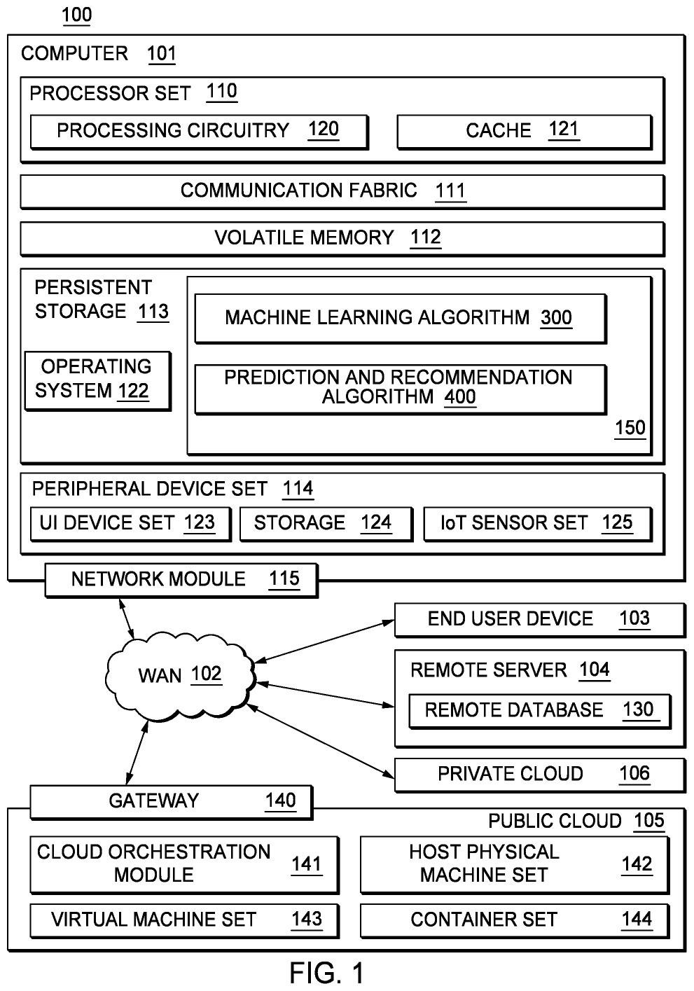

FIG. 1 illustrates a computing environment 100, according to one embodiment. Computing environment 100 contains an example of an environment for the execution of at least some of the computer code involved in performing the inventive methods, such as a new machine learning algorithm 300 and prediction and recommendation algorithm 400 shown in block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

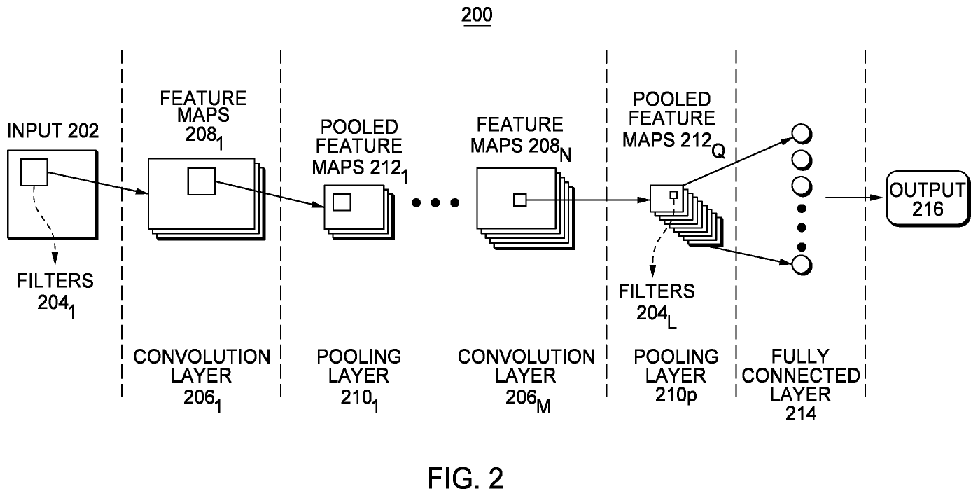

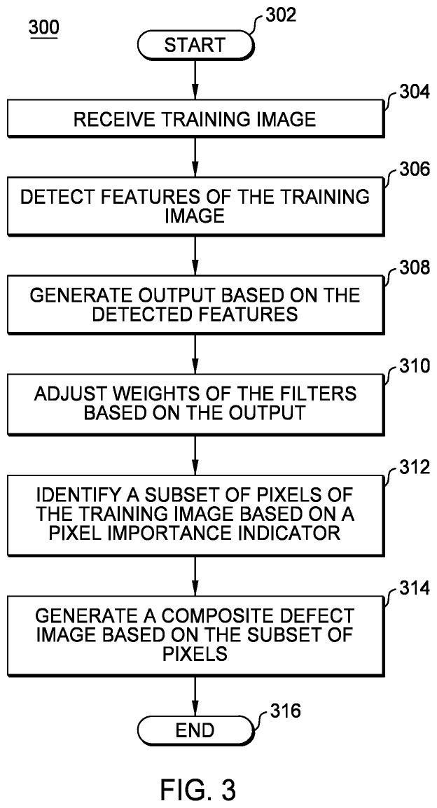

As discussed above, embodiments of the present disclosure involve identifying manufacturing defects in semiconductors from images of semiconductor layers. In one embodiment, a machine learning algorithm 300 implements a convolutional neural network (CNN) to identify the defects. The CNN is trained via a supervised learning process, where the CNN identifies a subset of pixels of a training image that has the greatest impact (relative to other pixels of the training image) on determining whether the training image shows a defect of a semiconductor layer. The machine learning algorithm 300 can then generate a composite defect image of the subset of pixels found among the training images. This process is described in further detail in FIGS. 2 and 3.

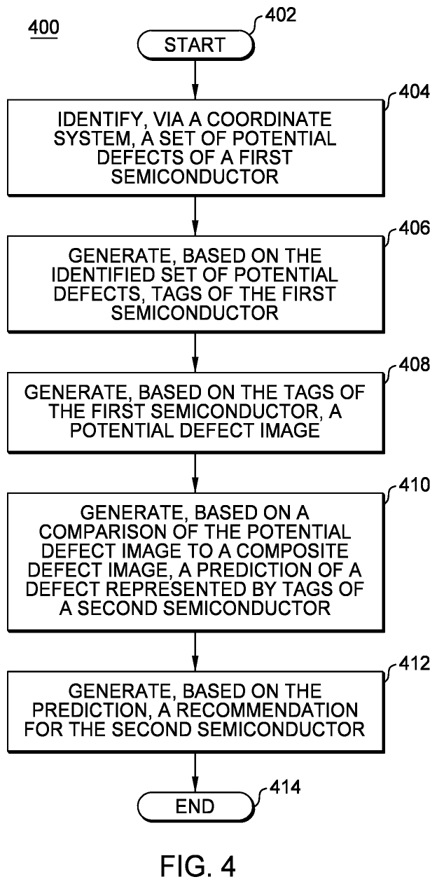

A prediction and recommendation algorithm 400 can implement the machine learning algorithm 300 to compare the composite defect image to input images of semiconductor layers, and predict whether the input images show a defect. Further, the prediction and recommendation algorithm 400 can generate recommended uses for defective semiconductors based on the prediction results. These processes are described in further detail in FIG. 4.

FIG. 2 illustrates a convolutional neural network 200, according to one embodiment. FIG. 3 illustrates a flowchart of a method of implementing a machine learning algorithm 300 to generating a composite defect image, according to one embodiment. FIG. 2 is explained in conjunction with FIG. 3.

In the embodiment illustrated in FIG. 2, the CNN 200 includes an input 202, filters 204_{1-L}, convolutional layers 206_{1-M}, feature maps 208_{1-N}, pooling layers 210_{1-P}, pooled feature maps 212_{1-Q}, a fully connected layer 214, and an output 216. The method begins at block 302. Blocks 302-310 represent one example of training the CNN 200.

At block 304, the machine learning algorithm 300 receives a training image. In the embodiment illustrated in FIG. 2, each input 202 is a labeled training image that shows defects of a semiconductor layer. The training image can be captured via electron beam imaging, microscope imaging, and the like. In one embodiment, the training images are from a set of previously captured images of semiconductor layers. In another embodiment, the training images are produced from images taken during the semiconductor manufacturing process. In yet another embodiment, the training images are produced from a failure analysis process of defective semiconductor products that were returned by consumers. For instance, when a semiconductor product is returned, a portion of a layer of the semiconductor can be removed (e.g., via ion beam milling, a scraping process, etc.) to expose an underlying surface that may include defects. Images of the underlying surface can be captured to generate the training images.

The defects can include under-deposits or over-deposits of material used in the fabrication or manufacturing process (e.g., bumps, pits, holes, etc.), presences of irregular shapes of the semiconductor product (e.g., incorrect dimensions, edge features, etc.), presence of foreign substances (e.g., dust, oil, etc.), compromised structural integrity (e.g., cracks, chip fragmentation, etc.), absent or misplaced features (e.g., missing solder, missing circuit print for integrated circuits, offset circuit print, etc.), and the like.

At block 306, the machine learning algorithm 300 detects features of the training image. In the embodiment illustrated in FIG. 2, the features of the training image are detected via the convolutional layers 206_{1-M} and the pooling layers 210_{1-P}.

Each of the convolutional layers 206_{1-M} can apply filters 204_{1-L} to the training image, the feature maps 208_{1-N}, or the pooled feature maps 212_{1-Q}, to identify features in the form of the feature maps 208_{1-N}. In one embodiment, a first set of the filters 204_{1-L} includes a matrix or array of weights, which represents a predetermined aspect of the training image (e.g., a line, shape, curve, etc.). The first set of the filters 204_{1-L} is convolved over the training image, and a dot product is calculated between the weights of the filter and the values of pixels of the training image. In one embodiment, this process repeats until the first set of the filters 204_{1-L} has covered the entire training image. The resultant series of dot products forms a first set of the feature maps 208_{1-N}. After each of the convolutional layers 206_{1-M}, an activation layer (not shown) applies an activation function to the resultant feature maps 208_{1-N}.

Each of the pooling layers 210_{1-P} can apply the filters 204_{1-L} to the feature maps 208_{1-N} to reduce the dimensions of the feature maps 208_{1-N}. In one embodiment, a second set of the filters 204_{1-L} is convolved across the first set of the first set of the feature maps 208_{1-N} in a process similar to the process performed in the convolutional layers 206_{1-M} described above. However, the second set of the filters 204_{1-L} may use values from a down-sampling function in lieu of filter weights. The resultant series of dot products forms a first set of the pooled feature maps 212_{1-Q}.

At block 308, the machine learning algorithm 300 generates an output based on the detected features. In the embodiment illustrated in FIG. 2, each of the pooled feature maps 212_{1-Q} are mapped to a node of the fully connected layer 214. The fully connected layer 214 performs a classification or regression analysis of the features of the pooled feature maps 212_{1-Q} to identify objects and aspects of the training image, and generates an output 216 that represents a probability that the identifications are correct. In one embodiment, the fully connected layer 214 also applies an activation function to its classifications to normalize the output 216. The output 216 can represent a probability distribution among classifications of features of the training image.

For example, the fully connected layer 214 may classify the aggregate shapes shown in the pooled feature maps 212_{1-Q} as being representative of different types of semiconductor defects shown in the training image. Hence, in one embodiment, the output 216 of the fully connected layer 214 is a probability distribution of which defects are shown in the training image. In another embodiment, the output 216 represents a binary distribution for the classifications of the presence and absence of defects shown in the training image.

At block 310, the machine learning algorithm 300 adjusts weights of the filters 204_{1-L} based on the output 216. In one embodiment, the machine learning algorithm 300 generates a loss function that captures a difference between the output 216 and an expected output as determined from the labels of the training image. The machine learning algorithm 300 can apply an optimization technique to the loss function (e.g., gradient descent) to determine updates for the weights of the filters 204_{1-L}. The machine learning algorithm 300 then updates the weights of the filters by back-propagating the updates throughout the CNN 200. Blocks 302-310 can be repeated until the CNN 200 is fully trained.

At block 312, the machine learning algorithm 300 identifies a subset of pixels of the training image based on a pixel importance indicator (PII). In one embodiment, the PII indicates how influential the subset of pixels is to a classification of the output 216.

In one embodiment, the PII comprises values of elements of the feature maps 208_{1-N}. As described above, a feature map is made from the dot product of the weights of a filter, and the values of the pixels over which the filter is convolved. For each classification of the output 216 that indicates the presence of a defect in the input image, the machine learning algorithm 300 can evaluate the elements of the feature maps 208_{1-N} to determine which pixels resulted in the largest element values. The resultant subset of pixels may represent a portion of a defect shown in the image (e.g., the subset of pixels may include 1-5 pixels, while the defect may include at least hundreds of pixels). In this manner, the machine learning algorithm 300 can identify a subset of pixels for each classification of the output 216 that indicates the presence of a defect.

While a PII is discussed, other types of indicators can be used to identify a subset of the input image. For example, a heat map or a matrix could be used.

At block 314, the machine learning algorithm 300 generates a composite defect image based on the subset of pixels. Hence, the composite defect image can represent a collection of pixels that have the greatest influence on a classification of the output 216 that indicates the presence of a defect. Put differently, the composite defect image can represent a collection of pixels that are the probabilistic drivers of a classification of the output 216.

In one embodiment, the machine learning algorithm 300 generates the composite defect image by randomly filling a blank image with the subsets of pixels. In another embodiment, the machine learning algorithm 300 fills the blank image with the subsets of pixels in the sequence in which the subsets of pixels were identified at block 312. The method ends at block 316.

FIG. 4 illustrates a flowchart of a method of implementing a prediction and recommendation (PR) algorithm 400 to predict potential semiconductor defects and generate recommendations for defective semiconductors, according to one embodiment. In one embodiment, the PR algorithm 400 implements the machine learning algorithm 300 to compare the composite defect image to input images of semiconductor layers. The PR algorithm 400 can also predict whether semiconductors are defective, without performing further image analysis. Afterwards, the PR algorithm 400 can recommend alternate uses for the semiconductors predicted to be defective.

The method begins at block 402. At block 404, the PR algorithm 400 identifies, via a coordinate system, a set of potential defects of a first semiconductor. In one embodiment, the coordinate system represents a three-dimensional space of a semiconductor manufacturing area.

During the manufacturing process, the PR algorithm 400 can observe each semiconductor layer, and identify the location of each potential defect on the layer. For example, when fabricating chips from wafers, the PR algorithm 400 can identify potential defects on a base wafer layer; on an oxide film disposed on the wafer; on an insulation layer disposed on the oxide film before and after each photolithography, etching, deposition, and doping process; on a metal or conductive film before and after a wiring process; and on the final chip before and after a wafer cutting, chip bonding, wire bonding, and molding process.

The potential defects identified by the PR algorithm 400 can include under-deposits or over-deposits of material (e.g., bumps, pits, holes, etc.), presences of irregular shapes of a layer (e.g., incorrect dimensions, edge features, etc.), presence of foreign substances (e.g., dust, oil, etc.), compromised structural integrity (e.g., cracks, substrate fragmentation, etc.), absent or misplaced features (e.g., missing solder, missing circuit print, offset circuit print, etc.), and the like.

At block 406, the PR algorithm 400 generates, based on the identified set of potential defects, tags of the first semiconductor. In one embodiment, upon identifying a potential defect on a semiconductor layer, the PR algorithm 400 tags the potential defect on the coordinate system. For example, for each potential defect of the first semiconductor, the PR algorithm 400 can place an eigenvector on the coordinate system to represent a location, orientation, or dimension of the corresponding potential defect.

This process is repeated for all of the potential defects of the first semiconductor. In this manner, the tags can represent all of the potential defects for each layer of the first semiconductor. The PR algorithm 400 then stores the tag information in a memory or storage.

At block 408, the PR algorithm 400 generates, based on the tags of the first semiconductor, a potential defect image. When generating the potential defect image, the PR algorithm 400 can overlay the coordinate system on a template image of the first semiconductor. Afterwards, the PR algorithm 400 can use the tag information to recreate the location, orientation, or dimension of each potential defect on the coordinate system. In this manner, a potential defect image can be generated for each layer of the first semiconductor.

At block 410, the PR algorithm 400 generates, based on a comparison of the potential defect image to a composite defect image, a prediction of a defect represented by tags of a second semiconductor. The prediction process can be performed during or after the manufacturing process. Further, the prediction process can be performed without needing to generate potential defect images for the second semiconductor, or to perform a machine learning assessment of these images.

Details of the composite defect image are described above in FIG. 3. Further, in one embodiment, the composite defect image is used to generate the filters 204_{1-L} of the CNN 200 such that the machine learning algorithm 300 detects defects that are represented by the composite defect image when the filters 204_{1-L} are convolved over the potential defect image. The machine learning algorithm 300 can use these filters as described in FIG. 3 above to determine whether the potential defect image shows an actual defect. In one embodiment, an “actual defect” refers to a determination by the machine learning algorithm that a defect is present physically present on a semiconductor. However, the actual defect may or may not compromise operation, or cause a failure, of the semiconductor.

When the machine learning algorithm 300 determines that the potential defect image of the first semiconductor shows an actual defect, the PR algorithm 400 can compare the tags of the first semiconductor to the tags of a second semiconductor. The tags of the second semiconductor can be generated in a process similar to that of the tags of the first semiconductor.

In one embodiment, the PR algorithm 400 performs the comparison by identifying overlaps or similarities between the tags of the first and second semiconductors to generate a similarity indicator value, and determining whether the similarity indicator value exceeds a threshold value. The prediction can indicate whether or not the second semiconductor is defective; the types of defects that are present; or the location, orientation, or dimensions of the defects.

For example, the PR algorithm 400 may determine that 70% of the eigenvectors corresponding to a layer of the second semiconductor have the same values, or similar values, to eigenvectors corresponding to a layer of the first semiconductor (for which the potential defect image was found to show an actual defect). If the threshold is set to 60%, then the PR algorithm 400 can determine, or predict, that the layer of the semiconductor has an actual defect. Hence, the PR algorithm 400 can predict whether the tags of the second set of also represent actual defects (without needing to generate potential defect images for the second semiconductor, or perform a machine learning assessment of these images).

As discussed above, the prediction process can be performed during or after the manufacturing process. When performed during the manufacturing process, the PR algorithm 400 can use the prediction to update or recalibrate the manufacturing process to prevent further fabrication of semiconductors with the predicted defects in real time. When performed after the manufacturing process, the prediction algorithm 400 can streamline the failure analysis process of a returned semiconductor by using the prediction of defects of the return semiconductor in lieu of traditional failure analysis process.

Hence, one benefit of using the predictions is to enable rapid identification of semiconductor defects. Therefore, the time and costs associated with traditional failure analysis processes (e.g., performing milling and scraping processes, conducting diagnosis, and the like) can be reduced or eliminated.

At block 412, the PR algorithm 400 generates, based on the prediction, a recommendation for the second semiconductor. In one embodiment, the PR algorithm 400 uses the prediction to identify an area of concern of the second semiconductor, and recommends a use for the second semiconductor that does not engage the area of concern. In one embodiment, the recommendation includes an identification of specific uses of the semiconductor, an identification of specific applications of the semiconductor, or updates to pricing that reflect the ability of the semiconductor to perform the specific uses or applications while containing areas of concern that may otherwise compromise performance of the semiconductor.

For example, the semiconductor may be a general-purpose chip that includes cryptography operations performed by pins 1 and 2 of the chip, and sorting operations performed across pins 3 and 4 of the chip. If an electrical path between pins 1 and 2 traverses the area of concern, but no electrical paths between pins 3 and 4 traverse the area of concern, then the PR algorithm 400 may recommend that the chip only be used for sorting operations.

Continuing the above example, the chip may have been originally designated for use on the motherboard of an enterprise grade computer. If the chip is used in a different, low-power environment, the defects may never compromise performance of the chip. Hence, in this example, the PR algorithm 400 may recommend that the chip be used in a mobile device, where the demands put on the chip are greatly reduced.

Continuing the above example, the PR algorithm 400 may suggest a price point at which the chip should be sold, given the defects of the chip. For instance, the PR algorithm 400 can suggest a sales price for the chip that is equivalent to an ASIC of comparable performance for the non-defective portions of the chip.

One benefit to recommending alternate uses based on the prediction of defects is to mitigate the effects of defects on semiconductor performance by avoiding use of the semiconductor that implicates the defects. The method ends at block 414.

While the foregoing is directed to embodiments of the present invention, other and further embodiments of the invention may be devised without departing from the basic scope thereof, and the scope thereof is determined by the claims that follow.

What is claimed is:

1. A method, comprising:
identifying, based on an indicator, a subset of an input image of a semiconductor;
generating, based on the subset of the input image, a composite defect image that represents a collection of pixels that are probabilistic drivers of a classification of the semiconductor defect;
identifying, via a coordinate system, a set of potential defects of a first semiconductor;
generating, based on the coordinate system and the identified set of potential defects, tags of the first semiconductor;
generating, based on the tags of the first semiconductor, a potential defect image; and
comparing the potential defect image to the composite defect image to determine a classification of an actual defect represented by the potential defect image.

2. The method of claim 1, further comprising:
generating, based on the comparison of the potential defect image to the composite defect image, a prediction of a defect represented by tags of a second semiconductor; and
generating, based on the prediction, a recommendation for the second semiconductor.

3. The method of claim 1, wherein the indicator is a pixel importance indicator that indicates a measure of influence of a subset of pixels on a defect classification output, and wherein the pixel importance indicator comprises values of elements of feature maps.

4. The method of claim 3, wherein the subset the input image includes a range of 1-5 pixels associated with a semiconductor defect represented by the input image, and wherein the subset of the input image corresponds to the largest of the values of elements of the feature maps.

5. The method of claim 1, wherein the set of potential defects of the first semiconductor comprises at least one of: (i) under-deposits or over-deposits of material on a layer of the first semiconductor; (ii) irregular shapes of the layer of the first semiconductor; (iii) foreign substances on the layer of the first semiconductor; (iv) compromised structural integrity of the layer of the semiconductor; or (v) absent or misplaced features of the layer of the first semiconductor.

6. The method of claim 1, wherein the tags of the first semiconductor represent locations, orientations, or dimensions of the set of potential defects of the first semiconductor.

7. The method of claim 2, wherein the recommendation includes at least one of: (i) an identification of specific uses of the second semiconductor; (ii) an identification of specific applications of the second semiconductor; or (iii) updates to pricing of the second semiconductor.

8. A system, comprising:
a processor; and
memory or storage comprising an algorithm or computer instructions, which when executed by the processor, performs an operation comprising:
identifying, based on an indicator, a subset of an input image of a semiconductor;
generating, based on the subset of the input image, a composite defect image that represents a collection of pixels that are probabilistic drivers of a classification of a semiconductor defect;
identifying, via a coordinate system, a set of potential defects of a first semiconductor;
generating, based on the coordinate system and the identified set of potential defects, tags of the first semiconductor;
generating, based on the tags of the first semiconductor, a potential defect image; and
comparing the potential defect image to the composite defect image to determine a classification of an actual defect represented by the potential defect image.

9. The system of claim 8, the operation further comprising:
generating, based on the comparison of the potential defect image to the composite defect image, a prediction of a defect represented by tags of a second semiconductor; and
generating, based on the prediction, a recommendation for the second semiconductor.

10. The system of claim 8, wherein the indicator is a pixel importance indicator that indicates a measure of influence of a subset of pixels on a defect classification output, and wherein the pixel importance indicator comprises values of elements of feature maps.

11. The system of claim 10, wherein the subset of the input image includes a range of 1-5 pixels associated with a semiconductor defect represented by the input image, and wherein the subset of the input image corresponds to the largest of the values of elements of the feature maps.

12. The system of claim 8, wherein the a set of potential defects of the first semiconductor comprises at least one of: (i) under-deposits or over-deposits of material on a layer of the first semiconductor; (ii) irregular shapes of the layer of the first semiconductor; (iii) foreign substances on the layer of the first semiconductor; (iv) compromised structural integrity of the layer of the semiconductor; or (v) absent or misplaced features of the layer of the first semiconductor.

13. The system of claim 8, wherein the tags of the first semiconductor represent locations, orientations, or dimensions of the set of potential defects of the first semiconductor.

14. The system of claim 9, wherein the recommendation includes at least one of: (i) an identification of specific uses of the second semiconductor; (ii) an identification of specific applications of the second semiconductor; or (iii) updates to pricing of the second semiconductor.

15. A computer-readable storage medium having computer-readable program code embodied therewith, the computer-readable program code executable by one or more computer processors to perform an operation comprising:
identifying, based on an indicator, a subset of an input image of a semiconductor;
generating, based on the subset of the input image, a composite defect image that represents a collection of pixels that are probabilistic drivers of a classification of a semiconductor defect;
identifying, via a coordinate system, a set of potential defects of a first semiconductor;
generating, based on the coordinate system and the identified set of potential defects, tags of the first semiconductor;
generating, based on the tags of the first semiconductor, a potential defect image; and
comparing the potential defect image to the composite defect image to determine a classification of an actual defect represented by the potential defect image.

16. The computer-readable storage medium of claim 15, the operation further comprising:
generating, based on the comparison of the potential defect image to the composite defect image, a prediction of a defect represented by tags of a second semiconductor; and
generating, based on the prediction, a recommendation for the second semiconductor.

17. The computer-readable storage medium of claim 15, wherein the indicator is a pixel importance indicator that indicates a measure of influence of the subset of pixels on a defect classification output, wherein the pixel importance indicator comprises values of elements of feature maps, wherein the subset of the input image includes a range of 1-5 pixels associated with a semiconductor defect represented by the input image, and wherein the subset of pixels correspond to the largest of the values of elements of the feature maps.

18. The computer-readable storage medium of claim 15, wherein the a set of potential defects of the first semiconductor comprises at least one of: (i) under-deposits or over-deposits of material on a layer of the first semiconductor; (ii) irregular shapes of the layer of the first semiconductor; (iii) foreign substances on the layer of the first semiconductor; (iv) compromised structural integrity of the layer of the semiconductor; or (v) absent or misplaced features of the layer of the first semiconductor.

19. The computer-readable storage medium of claim 15, wherein the tags of the first semiconductor represent locations, orientations, or dimensions of the set of potential defects of the first semiconductor.

20. The computer-readable storage medium of claim 16, wherein the recommendation includes at least one of: (i) an identification of specific uses of the second semiconductor; (ii) an identification of specific applications of the second semiconductor; or (iii) updates to pricing of the second semiconductor.
